(19) United States
(12) Patent Application Publication
(10) Pub. No.: US 2024/0106624 A1
(43) Pub. Date: Mar. 28, 2024

(54) MODULATING POWER CONSUMPTION FROM A POWER SOURCE THAT SUPPLIES A DATA-DEPENDENT POWER CONSUMER

(71) Applicant: Microchip Technology Incorporated, Chandler (AZ)

(72) Inventors: Herman Hok Man Leung, Richmond (CA); Rod Zavari, North Vancouver (CA); Predrag Acimovic, Chandler, AZ (US)

(21) Appl. No.: 18/473,081

(22) Filed: Sep. 22, 2023

Related U.S. Application Data
(60) Provisional application No. 63/376,864, filed on Sep. 23, 2022.

(51) Int. Cl. H04L 7/04; H04L 7/033; H04L 25/49

(52) U.S. Cl. CPC H04L 7/042; H04L 7/0337; H04L 25/4917

(57) ABSTRACT

A method may include setting a data pattern status signal to indicate a data pattern status of a data pattern to be received by a data-dependent power consumer; and modulating power consumption from a power source that provides the data-dependent power consumer at least partially based on the set data pattern status signal.

### CROSS-REFERENCE TO RELATED APPLICATION

This application claims the benefit under 35 U.S.C. § 119(e) of the priority date of U.S. Provisional Patent Application Ser. No. 63/376,864, filed Sep. 23, 2022, for IDLE PATTERN DETECTION AND CURRENT COMPENSATION, METHOD AND APPARATUS FOR REDUCING DATA DEPENDENT POWER SOURCE CURRENT VARIATION, the contents and disclosure of which is incorporated herein in its entirety by this reference.

### FIELD

One or more examples relate to modulating power consumption from a power source that supplies one or more data-dependent power consumers. One or more examples relate to determining presence of idle data patterns. One or more examples relate to compensating for a reduction in power consumption by a data-dependent power consumer due to idle data patterns.

### BACKGROUND

Electronic communication systems and computer buses and interfaces for the same are used in a variety of operational contexts.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram depicting an apparatus to compensate for reduced power consumption due to data-dependent power consumption, in accordance with one or more examples.

FIG. 2 is a block diagram depicting a system that compensates for reduced power consumption by a data-dependent power consumer, in accordance with one or more examples.

FIG. 3 is a block diagram depicting an apparatus to determine the data pattern status of data patterns 106, in accordance with one or more examples.

FIG. 4 is a block diagram of an apparatus that uses autocorrelation to determine data pattern status, in accordance with one or more examples.

FIG. 5 is a block diagram of an apparatus that conditions power modulation on data pattern status signals of multiple data pattern detectors, in accordance with one or more examples.

FIG. 6 is a block diagram of an apparatus that aligns power modulation in a sequential manner, in accordance with one or more examples.

FIG. 7 is a schematic diagram of a current sink activated in response to a detection signal generated by an idle pattern detector, in accordance with one or more examples.

FIG. 8 is a block diagram depicting a system that compensates for reduced power consumption by data-dependent power consumers of a serial interface, in accordance with one or more examples.

FIG. 9 is a flow diagram depicting a process of compensating for reduced power consumption due to data-dependent power consumption, in accordance with one or more examples.

FIG. 10 is a flow diagram depicting a process of setting the data pattern status signal to indicate a data pattern status of a data pattern to be received by a data-dependent power consumer, in accordance with one or more examples.

FIG. 11 is a flow diagram depicting a process of a data pattern status of a data pattern at least partially based relationships of symbols of the data pattern, in accordance with one or more examples.

FIG. 12 is a flow diagram depicting a process of determining data pattern status of the data pattern at least partially based on a frequency at which the identified relationships change, in accordance with one or more examples.

FIG. 13 is a flow diagram depicting a process of determining data pattern status of the data pattern based on autocorrelations, in accordance with one or more examples.

FIG. 14 illustrates an example process of determining data pattern status of the data pattern based on autocorrelations, in accordance with one or more examples.

FIG. 15 is a block diagram of circuitry that, in some examples, may be used to implement various functions, operations, acts, processes, or methods disclosed herein.

### DETAILED DESCRIPTION

In the following detailed description, reference is made to the accompanying drawings, which form a part hereof, and in which are shown, by way of illustration, specific examples of examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example or this disclosure to the specified components, steps, features, functions, or the like.

It will be readily understood that the components of the examples as generally described herein and illustrated in the drawing could be arranged and designed in a wide variety of different configurations. Thus, the following description of various examples is not intended to limit the scope of the present disclosure, but is merely representative of various examples. While the various aspects of the examples may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the examples disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer includes or executes computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, any relational term, such as “over,” “under,” “on,” “underlying,” “upper,” “lower,” without limitation, is used for clarity and convenience in understanding the disclosure and accompanying drawings and does not connote or depend on any specific preference, orientation, or order, except where the context clearly indicates otherwise.

In this description the term “coupled,” and derivatives thereof, may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The term “connected” may be used in this description interchangeably with the term “coupled,” and has the same meaning unless expressly indicated otherwise or the context would indicate otherwise to a person having ordinary skill in the art.

As used herein, the term “assert” when used with “signal” means to set a signal to an active state. As used herein, the term “de-assert” when used with “signal” means to set a signal to an inactive or default state. For example, signals may be active high and inactive low, or active low and inactive high.

A “clock signal” is a signal that oscillates between two discrete states—a low state and a high state—in a reliably predictable manner. One or more circuits may be responsive to a rising edge or falling edge of a clock, as a non-limiting example, to coordinate acts. The terms “clock signal” and “clock” are used interchangeably herein to mean “clock signal.”

A “data pattern” is a sequence of symbols. Respective symbols of a data pattern may represent one or more bits of data, e.g., one bit of data (e.g., Pulse-Amplitude Modulation (PAM) 2) symbol, a Binary Phase Shift Keying (Binary PSK or BPSK) symbol, a Binary Frequency Shift Keying (Binary FSK or BFSK) symbol, without limitation), two bits of data (e.g., a PAM-4 symbol, a Quadrature PSK (QPSK) symbol, a 4-FSK symbol, without limitation), three bits of data (e.g., a PAM-8 symbol, without limitation), or four bits of data (e.g., 16-QAM (Quadrature Amplitude Modulation) symbol, without limitation), without limitation.

It is desirable for data patterns on a serial link (e.g., on a serial interface for communication via a computer bus, without limitation) to exhibit a uniform distribution of data values, sometimes referred to as “statistical randomness” or “pseudo-randomness.” A data pattern that exhibits statistical randomness is referred to herein as a “random data pattern.” While the desire for statical randomness depends on specific technical or operational objectives, non-limiting examples include: reducing electromagnetic interference or preventing long runs of the same value which make synchronization harder (e.g., due to lost clock, baseline wander, or error propagation, without limitation). Scrambling is often used to randomize data, i.e., to increase uniform distribution of data values exhibited by data patterns on a serial link.

An “idle data pattern” is a repetitive, aligned data pattern of valid symbols. Idle data patterns may be present on a serial link (e.g., on a datapath of a serial interface, without limitation). In the case of a multilane serial link, an idle data pattern may be present on some or a totality of respective lanes of the serial link. Idle data patterns may exhibit repetitive changes in symbols with a constant data pattern (e.g., changes in signal level, without limitation). Idle data patterns may reduce the uniformity of distribution of data values on a serial link, i.e., there is lack of randomness in the data values.

There are a number of sources of idle data patterns, a non-limiting example is control and management data patterns. PCIe (Peripheral Component Interconnect Express) and other serial communication interfaces (high-speed or otherwise) use predetermined data patterns, sometimes also referred to as “ordered sets,” for control and management functions. Non-limiting examples of control and management data patterns include Skip Ordered Sets (SKP) and Training Sequence 1 (TS1). SKP are periodically inserted by a transmitter to allow a receiver to maintain synchronization in high-speed serial links by either skipping the SKP or using them to align a local clock. TS1 is used in link initialization and training process to, for example, enable the receiver to set its equalization settings and establish the link. Respective instances of control and management data patterns, such as SKP and TS1, without limitation, include substantially the same sequences of symbols and many instances of control and management data patterns may occur when these functions are performed. Control and management data patterns are a non-limiting example of a source of idle data patterns.

Data converters (e.g., analog-to-digital converters (ADC), digital-to-analog converters (DAC), data rate converters, without limitation) may operate in a datapath (a single datapath in the case of single lane, and multiple datapaths (or “lanes”) in the case of multilane) of a serial interface. The power consumption profile of a data converter (e.g., a time interleaved data converter, without limitation) processing an idle data pattern may be vastly different than the power consumption profile of the same data converter processing a random data pattern. When a data pattern repeats, the power consumption of the data converter is smaller than when a data pattern is random. Dynamic power consumption is at least partially responsive to frequency and transition density. For example, when a data pattern is random, there are more transitions that cause internal node capacitances of a circuit to charge or discharge. The average power consumption of the data converter typically increases in response to changes from an idle data pattern to a random data pattern. The average power consumption of the data converter typically decreases, sometimes by a large amount, in response to a change from random data patterns to an idle data pattern. In an integrated circuit (IC), a large change in average power consumption, together with any parasitic inductance in the power delivery network, can cause a large voltage noise on the power source (e.g., >250 millivolts peak-to-peak (mVpp) on <1 V supply, without limitation) which can reduce IC performance, sometimes substantially.

In the case of receivers and transmitters, the reduced IC performance may reduce the jitter tolerance of the internal receiver and margins in the transmit eye. In the case of a transmitter, the degradation may be directly observable by the shape of the transmit eye. In some cases, filters, such as decoupling capacitances, may be used to filter out such voltage noise. In some cases, a highly sensitive voltage regulator, such as a low drop out (LDO), may be used (e.g., cascaded with decoupling capacitances, without limitation) so that a data converter can process data patterns in the presence of the voltage noise even if filtered by decoupling capacitances.

Devices and circuits that exhibit different power consumption profiles for idle data patterns as compared to random data patterns may be referred to herein as exhibiting “data-dependent power consumption” and such a device or circuit may be referred to herein as a “data-dependent power consumer.”

One or more examples relate to compensating for reduced power consumption due to data-dependent power consumption at a serial interface. In one or more examples, a data pattern detector is provided that receives data patterns, determines the data pattern status of the data patterns, and sets a data pattern status signal to indicate the determined data pattern status.

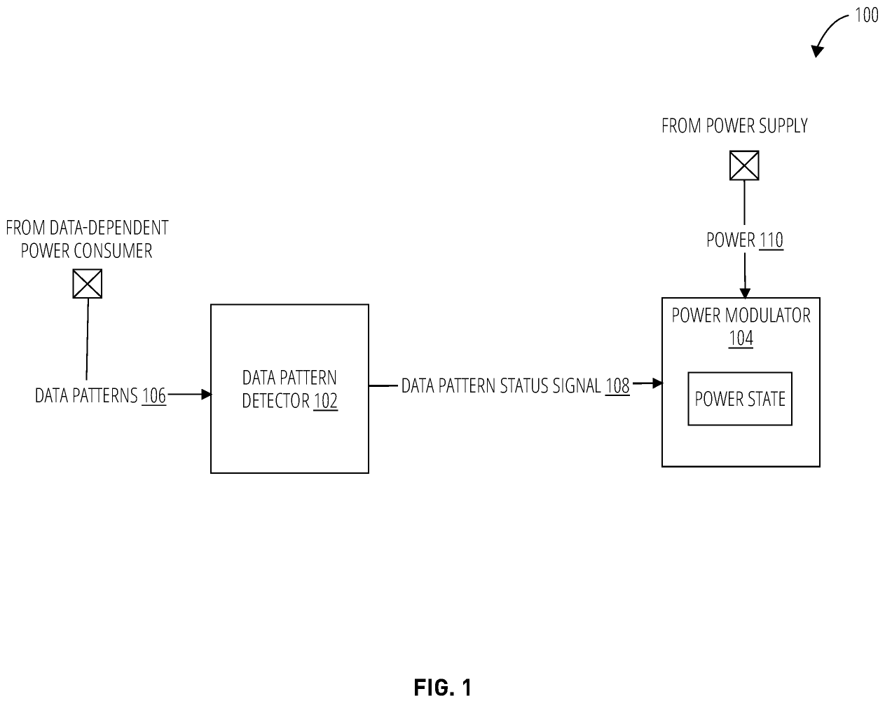

FIG. 1 is a block diagram depicting an apparatus 100 to compensate for reduced power consumption due to data-dependent power consumption, in accordance with one or more examples.

Apparatus 100 includes data pattern detector 102 and power modulator 104.

Generally speaking, apparatus 100 dynamically adjusts power consumption in response to data pattern status changes exhibited by data patterns 106. The data patterns 106 may be copies of, or otherwise indicative of, data patterns to be processed by a data-dependent power consumer. Respective adjustments to power consumption by apparatus 100 may correspond to changes in power consumption by the data-dependent power consumer. In cases when power consumption by the data-dependent power consumer would reduce in response to data patterns 106, respective adjustments in power consumption by apparatus 100 may compensate for some or a totality of the reduction in power consumption by the data-dependent power consumer. Thus, apparatus 100 may also be referred to herein as a “data-dependent power compensator 100.”

Data pattern detector 102 receives data patterns 106, determines a data pattern status of the data patterns 106, and sets data pattern status signal 108 to indicate the determined data pattern status of data patterns 106, as discussed below. Respective data pattern status determined by data pattern detector 102 may include one or more of: presence of idle data pattern or absence of an idle data pattern.

In one or more examples, a first value of data pattern status signal 108 set by data pattern detector 102 may indicate the presence of idle data pattern, and a second, different value of data pattern status signal 108 set by data pattern detector 102 may indicate the absence of the idle data pattern. In another example, the second value of data pattern status signal 108 set by data pattern detector 102 may indicate the lack of positive confirmation of the presence of an idle data pattern rather than its absence.

In one or more examples, a first value of data pattern status signal 108 set by data pattern detector 102 may indicate the presence of idle data pattern, a second value of data pattern status signal 108 set by data pattern detector 102 may indicate absence of idle data pattern, and a third value of data pattern status signal 108 set by data pattern detector 102 may indicate lack of positive confirmation of presence, absence, or both of idle data pattern.

In one or more examples, data pattern detector 102 may determine a degree of certainty and if the degree of certainty is greater than a predetermined threshold set data pattern status signal 108 to indicate presence of idle data pattern, and if the degree certainty is less than or equal to the predetermined threshold set data pattern status signal 108 to indicate lack of positive confirmation of presence, absence, or both of idle data pattern.

Additionally or alternatively, in one or more examples, data pattern detector 102 may set data pattern status signal 108 to a value that indicates a degree of certainty at least partially based on a degree of certainty determined by data pattern detector 102, and that value may be utilized by power modulator 104 to set an amount of current draw as discussed, below.

Power modulator 104 receives data pattern status signal 108 and sets its power state at least partially based thereon. Respective power states of power modulator 104 may include one or more power states where it consumes power 110, and a power state where it does not consume power or consumes negligible power. Power modulator 104 may set its power state to a first power state where it consumes power in response to data pattern status signal 108 indicating the presence of an idle data pattern. Power modulator 104 may set its power state to a second power state where it does not consume power in response to data pattern status signal 108 indicating the absence of an idle data pattern. In some cases, when power modulator 104 sets its power state to the first state where it consumes power, the amount of power 110 it consumes is set to compensate for a reduction in power consumption at a data-dependent power consumer, which data-dependent power consumer is operative on data patterns 106.

In one or more examples, power modulator 104 may include one or more controlled current sinks that may be selectively turned ON or OFF to set a power state of power modulator 104 and optionally set power 110 consumed by power modulator 104. When a controlled current sink is ON it is actively sinking current (drawing current) and may present a low impedance path, and when a controlled current sink is OFF it is inactive (not drawing current) and may present an open or high impedance path.

In one or more examples, respective controlled current sinks of power modulator 104 may be, or may include, one or more analog or digital circuits for performing the functions of sinking current, such as, without limitation: a switch controlled current sink such as a bipolar junction transistor (BJT) or metal-oxide-semiconductor field-effect transistor (MOSFET) controlled current sink that sinks current from a node the amount of which is set by a resistor; an operational amplifier (op-amp) controlled current sink that is used with a switch controlled current sink to precisely set and maintain the amount of current sunk from a node; a transistor-controlled current sink that uses a digital potentiometer to set the amount of current sunk from a node (the digital potentiometer controls the amount of sunk current based on a digital setting); a pulse-width-modulation (PWM) controlled current sink that rapidly switches a switch controlled current sink ON and OFF and by varying the duty cycle of the switching waveform, and thus controls the average current being sunk.

In one or more examples, the value of power 110 set by power modulator 104 may be at least partially based on an expected change in power consumption by the data-dependent power consumer. In one or more examples, the value of power 110 set by power modulator 104 may be predetermined based on an expected reduction in power consumed by the data-dependent power consumer in response to the presence of one or more idle data patterns. In one or more examples, the amount of power compensation, i.e., the value of power 110 set by power modulator 104, may be at least partially based on one or more power consumption profiles associated with the data-dependent power consumer. Such a power consumption profile describes the change in power consumption by the data-dependent power consumer based on content and length of data patterns, including without limitation, idle data patterns being processed. A power consumption profile may be obtained, as a non-limiting example, from a manufacturer, via testing, or both.

In one or more examples, power modulator 104 may set power 110 to a value that is proportional to a value of data pattern status signal 108. As a non-limiting example, the higher the value of data pattern status signal 108 the higher the amount of power 110 set by power modulator 104, and the lower the value of data pattern status signal 108 the lower the amount of power 110 set by power modulator 104. As a non-limiting example, if data pattern detector 102 sets data pattern status signal 108 to a value indicative of a presence of idle data pattern and a low certainty then power modulator 104 may set power 110 to a value lower than if the value of data pattern status signal 108 was indicative of presence of idle data pattern and a higher certainty. Power modulator 104 may set power 110 to higher and lower values in response to changing values of data pattern status signal 108 to indicate higher or lower certainty.

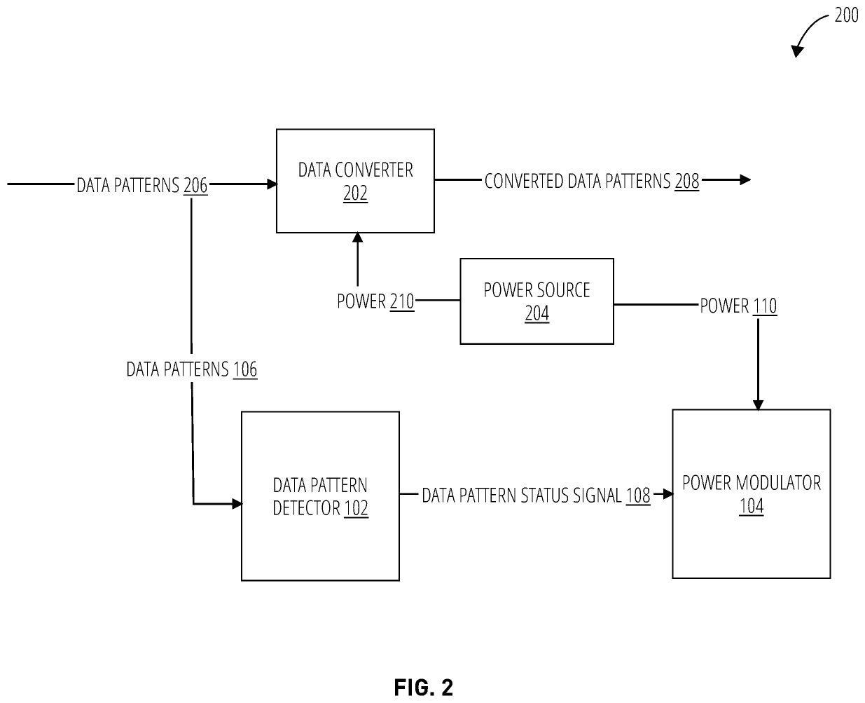

FIG. 2 is a block diagram depicting a system 200 that compensates for reduced power consumption by a data-dependent power consumer, in accordance with one or more examples.

System 200 includes data converter 202 and power source 204, and further includes data pattern detector 102 and power modulator 104 of FIG. 1. In this example, data pattern detector 102 and power modulator 104 operate as a data-dependent power compensator 100, discussed above.

Generally speaking, system 200 dynamically maintains power consumption through various data pattern status changes exhibited by data patterns 206 received by system 200. Data pattern detector 102 and power modulator 104 cooperate to dynamically adjust their power consumption in response to data pattern status changes exhibited by data patterns 206 and in an amount that corresponds to reductions in power consumption by data converter 202, which in this example, is the data-dependent power consumer.

Data converter 202 receives data patterns 206 and generate converted data patterns 208 at least partially responsive thereto. Data converter 202 converts data from one form to another, different form, such as: converting between analog and digital form, converting between voltage or current levels utilized to represent signals, converting between data rates, changing bit-depth of a value (e.g., changing between 8-bit and 16-bit, 2-bit and 4-bit, without limitation), and combinations and subcombinations thereof, without limitation. In one or more examples, data converter 202 may be an electronic device that performs functions related to data conversation, such as: analog-to-digital converter (ADC), digital-to-analog converter (DAC), a serial-to-parallel converter (e.g., a serial peripheral interface (SPI), without limitation), a parallel-to-serial converter (e.g., a PSI, without limitation), protocol converters (e.g., an Inter-Integrated Circuit (I²C) to SPI converter, without limitation), voltage level shifters, and combinations and sub-combinations thereof, without limitation.

Power source 204 provides the power (e.g., current, voltage, without limitation) utilized by data converter 202, power modulator 104 and optionally by data pattern detector 102.

The value of power 110 consumed by power modulator 104 corresponds to a change in a value of power 210 consumed by data converter 202 due to the presence of idle data patterns in data patterns 106 as compared to the lack of presence of such idle patterns in data patterns 106. Thus, the relationship between power 210 and power 110 is indirectly proportional. For a respective negative change (decrease) in power 210 there is a respective positive change (increase) in power 110, and for a respective positive change (increase) in power 210 there is a respective negative change (decrease) in power 110.

Data pattern detector 102 may utilize any suitable process to determine the data pattern status of data patterns 106, including determining presence or absence of idle data patterns, including without limitation filtering based techniques, non-filtering-based techniques, and combinations thereof.

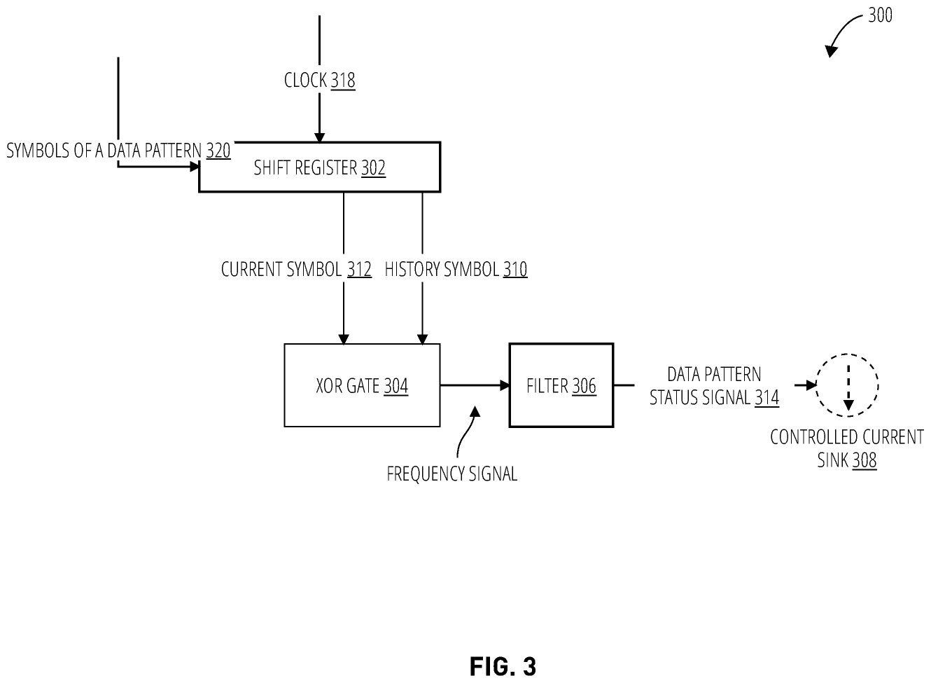

FIG. 3 is a block diagram depicting an apparatus 300 to determine the data pattern status of data patterns 106, in accordance with one or more examples.

Apparatus 300 includes shift register 302, exclusive OR (XOR) gate 304, and filter 306 respectively for idle pattern detection. Apparatus 300 may optionally include controlled current sink 308 for current draw compensation.

XOR gate 304 and filter 306 operate as a data pattern detector such as data pattern detector 102. Controlled current sink 308 operates as a power modulator such as power modulator 104. Shift register 302 is a source of symbols of a data pattern 320 presented to XOR gate 304, such as symbols of data patterns 106.

Generally speaking, apparatus 300 utilizes difference detection to identify symbol changes in symbols of a data pattern 320 and utilizes the identified symbol changes to determine data pattern status of the data pattern 320, as discussed below. Using symbol changes in symbols of a data pattern 320 may, as a non-limiting example, increase noise immunity.

Shift register 302 is a first-in-first-out (FIFO) shift-register that receives symbols of a data pattern 320, and shifts (moves) symbols, in sequence, by one symbol position towards its output in response to being triggered by clock 318.

XOR gate 304 is coupled to shift register 302 to perform difference detection between a symbol stored at a first symbol position of shift register 302 and a symbol stored at a second, different symbol position of shift register 302. In one or more examples, detection intervals may be generally aligned to clock cycles of clock 318, as a non-limiting example, via feeding symbols through shift register 302. Respective inputs of XOR gate 304 are coupled (e.g., via taps, without limitation) to respective bit positions of shift register 302 to receive bits stored in the respective bit positions. One of the inputs of XOR gate 304 is coupled to receive a history symbol 310 and the other one of the inputs is coupled to receive a current symbol 312.

In one or more examples, the history symbol 310 may have been the current symbol 312 in the immediately previous detection interval. In one or more examples, any two symbol positions of shift register 302 may be coupled to inputs of XOR gate 304 as long as the input used for history symbol 310 is coupled to a bit position that is earlier in time than a bit position coupled to the current symbol 312. In one or more examples, the big positions of shift register 302 may be adjacent or intervening bit positions may be present.

When current symbol 312 is the same as history symbol 310 the output of XOR gate 304 is a first value that indicates that the current symbol 312 is the same as history symbol 310 in response to the XOR action of XOR gate 304. When current symbol 312 is different than history symbol 310 the output of XOR gate 304 is a second, different value that indicates that the current symbol 312 is different than the history symbol 310 in response to the XOR action of XOR gate 304. The output of XOR gate 304 is coupled to an input filter 306.

Filter 306 receives the output of XOR gate 304, processes the output, and sets data pattern status signal 108 in response to the processing. Using the output of XOR gate 304 effectively uses indications of symbol changes to determine presence of idle data pattern.

By way of non-limiting example, assume Y represents the output of XOR gate 304 when history symbol 310 and current symbol 312 are different, and N represents the output of XOR gate 304 when history symbol 310 and current symbol 312 are the same. In the case of random data patterns, the frequency of changes in the output of XOR gate 304, e.g., from Y to N or N to Y, should appear to change, i.e., the output of XOR gate 304 should appear to be frequency-modulated. For idle data patterns, the frequency of changes in the output of XOR gate 304 should appear generally constant or within a narrow frequency band, i.e., frequency-stable.

In one or more examples, filter 306 may detect a frequency-stable output of XOR gate 304 and, conversely, may detect a frequency-modulated output of XOR gate 304. Filter 306 may utilize any suitable digital signal processing (DSP) technique to determine whether or not the output of XOR gate 304 is frequency-stable or frequency-modulated, such as band-pass filtering, moving average filtering, or Kalman filtering, without limitation.

In the case of band-pass filtering, filter 306 may include one or more band-pass filters that pass only frequencies within respective predetermined ranges. Frequency ranges of stable frequencies associated with repeating patterns may be pre-determined and used to configure respective band-pass filters. If the output of any filter of the bank of band-pass digital filters remains constant, then that indicates a stable-frequency and an idle data pattern. The outputs of the band-pass filters may set data pattern status signal 314 directly or, e.g., via an AND gate or an OR gate.

In the case of a moving average filtering, filter 306 may include a moving average filter that smooths out rapid variations a signal to exhibit a more gradual change. If the smoothed signal remains consistent over time, that will indicate a stable frequency and filter 306 sets data pattern status signal 314 to indicate the presence of an idle data pattern.

In the case of a Kalman filtering, filter 306 includes a Kalman filter that estimates the frequency of the output of XOR gate 304 and its rate of change. If the rate of change is near zero for some predetermined time duration, the frequency is deemed stable, indicating an idle data pattern, and filter 306 sets data pattern status signal 314 to indicate the presence of an idle data pattern.

In another example, filter 306 may include a phase detector (e.g., a time-to-digital converter (TDC), without limitation) that stores samples of the output of XOR gate 304 and compares the stored samples to current samples of the output of XOR gate 304 to determine if there is a phase difference. If the determined phase difference is zero (i.e., phase difference is at or near zero), optionally for some predetermined time duration, that indicates a stable frequency and filter 306 may set data pattern status signal 314 to indicate the presence of idle data pattern.

In one or more examples, a non-filtering based digital signal processing technique may be utilized to determine data pattern status, including, without limitation, autocorrelation. In digital signal processing (DSP), an autocorrelator computes the autocorrelation of a signal. The autocorrelation measures the similarity of a signal with a delayed version of the signal over a range of delays.

In one or more examples, autocorrelations are computed for data patterns over predetermined time intervals. If the autocorrelation is above a predetermined threshold, that indicates the presence of idle data pattern, and if the autocorrelation is less than or equal to the predetermined threshold, that indicates the absence of idle data pattern.

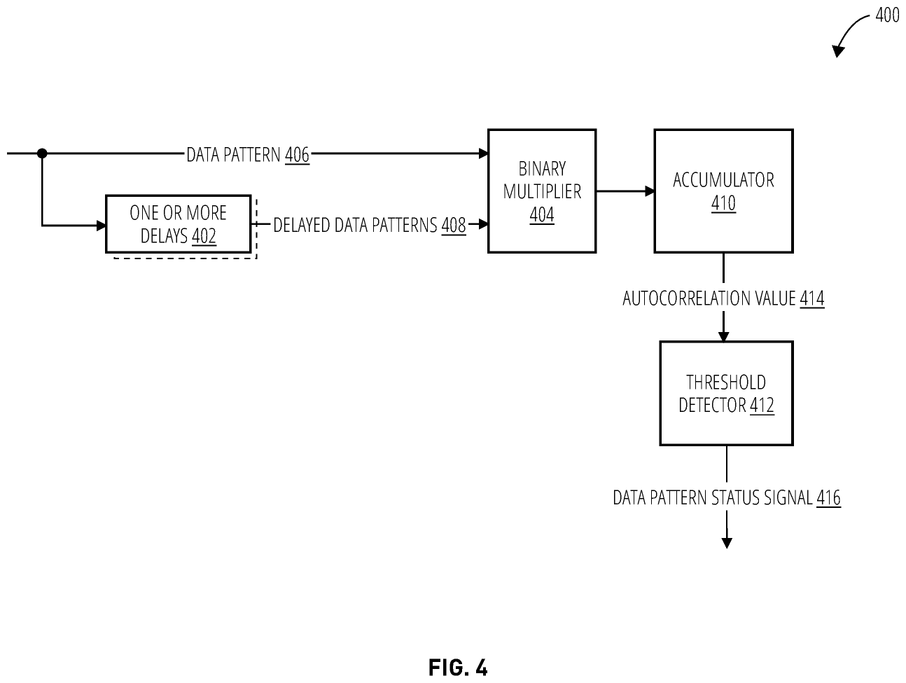

FIG. 4 is a block diagram of an apparatus 400 that uses autocorrelation to determine data pattern status, in accordance with one or more examples.

Apparatus 400 includes one or more delays 402, binary multiplier 404, accumulator 410 and threshold detector 412.

One or more delays 402 receive data pattern 406 and generate one or more delayed data patterns 408 at least partially responsive thereto. In one or more examples, one or more delays 402 may generate respective delayed data patterns 408 for a range of delays. One or more delays 402 may include multiple respective delays 402 and may generate a respective delayed data pattern 408 for each delay. Non-limiting examples of delays include one-symbol, two-symbol, three-symbol, or four-symbol delay. Other numbers of delays may be utilized without exceeding the scope of this disclosure.

Binary multiplier 404 receives data pattern 406 and respective delayed data patterns 408, computes the products of data pattern 406 with respective delayed data patterns 408, and provides the computed products to accumulator 410.

Accumulator 410 receives the computed products from binary multiplier 404 and sums the computed products over one or more predetermined time intervals. An accumulated value stored at accumulator 410 is the autocorrelation value 414 that represents the instantaneous autocorrelations of data pattern 406 for respective delays. The autocorrelation value 414 may change over time representing a change in instantaneous autocorrelation over time.

Equation 1 provides the autocorrelation value for a specific delay m. For a discrete sequence, the autocorrelation value 414 will be generated as an array of values (or a sequence), where each value corresponds to a specific delay.

R[m]=Σnx[n]·x[n+m] EQUATION 1

Where R[m] represents the autocorrelation value at delay m, x[n] is the signal value at index n, and x[n+m] is the signal value at an index n offset by m.

Threshold detector 412 receives the autocorrelation value 414 from accumulator 410 and determines if autocorrelation value 414 is less than a predetermined threshold or greater than or equal to the predetermined threshold. If autocorrelation value 414 is less than the predetermined threshold that indicates the absence of an idle data pattern. If autocorrelation value 414 is greater than or equal to the predetermined threshold that indicates the presence of an idle data pattern.

In this manner, apparatus 400 determines the pattern status (i.e., idle data pattern present or absent) of data pattern 406 utilizing autocorrelation and sets data pattern status signal 416 to indicate the determined pattern status.

In a multi-lane serial interface, each lane of the serial interface may include a data-dependent power consumer, such as a data converter affected by the presence of idle data patterns. In one or more examples, respective data-dependent power compensators, such as data-dependent power compensator 100 may be provided for some or a totality of such data-dependent power consumers.

In one or more examples, respective data-dependent power compensators per lane may independently (of each other) modulate power consumption as discussed above. In some cases, it may be desirable to align the power modulation by the various data-dependent power compensators.

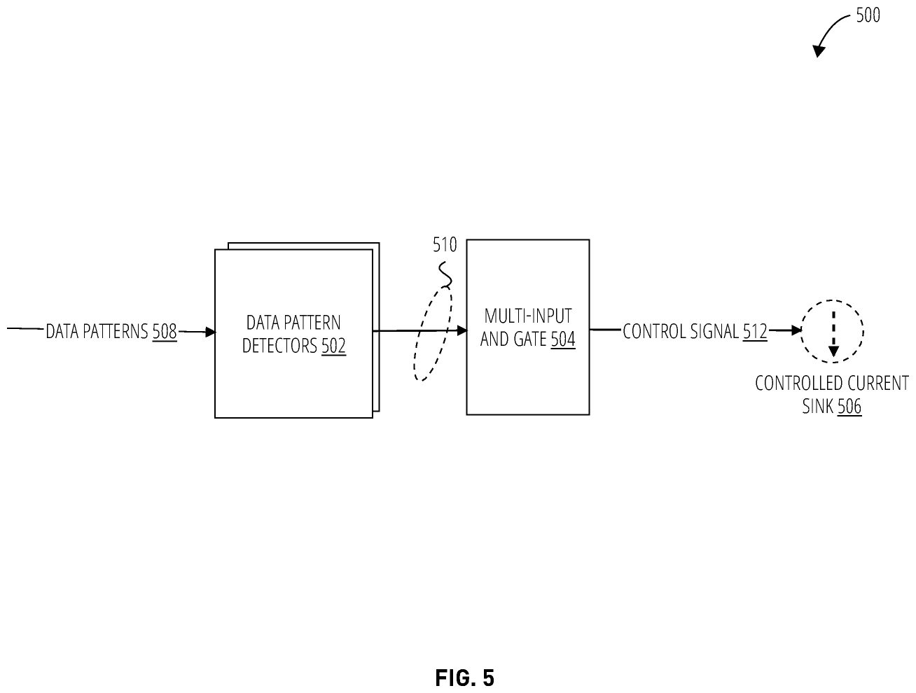

FIG. 5 is a block diagram of an apparatus 500 that conditions power modulation on data pattern status signals of multiple data pattern detectors, in accordance with one or more examples. Conditioning power modulation on data pattern status signals of respective data pattern detectors monitoring respective data patterns of respective data-dependent power consumers may also be referred to herein as “majority voting.”

In one or more example, respective data pattern detectors 502 may receive respective data patterns 508 from respective lanes of a multilane serial interface. Alternatively, some data pattern detectors 502 could receive respective data patterns 508 from respective lanes of a multilane serial interface and other data pattern detectors 502 could respective data patterns 508 from datapaths of other data-dependent power consumers.

Apparatus 500 includes data pattern detectors 502 and multi-input AND gate 504. Apparatus 500 optionally further includes controlled current sink 506. When apparatus 500 does not include controlled current sink 506, it may be referred to as a set of data pattern detectors 502. When apparatus 500 does include controlled current sink 506, it may be referred to as a majority voting conditioned data-dependent power compensator 500.

Respective data pattern detectors 502 receive respective data patterns 508 and generate respective data pattern status signals 510 at least partially responsive thereto. In one or more examples, respective data patterns 508 may be from respective lanes of a multilane serial interface.

Multi-input AND gate 504 receives the data pattern status signals 510 generated by data pattern detectors 502 and sets control signal 512 at least partially responsive thereto. Multi-input AND gate 504 and sets control signal 512 to activate controlled current sink 506 in response to a totality of data pattern status signals 510 being asserted by the data pattern detectors 502. Multi-input AND gate 504 sets control signal 512 to a first value that turns ON controlled current sink 506 in response to all of data pattern status signals 510 being asserted and sets control signal 512 to a second value that turns OFF controlled current sink 506 in response to any one of data pattern status signals 510 being de-asserted.

In this manner, compensation current draw is activated only when all of the data pattern status signals 510 are asserted.

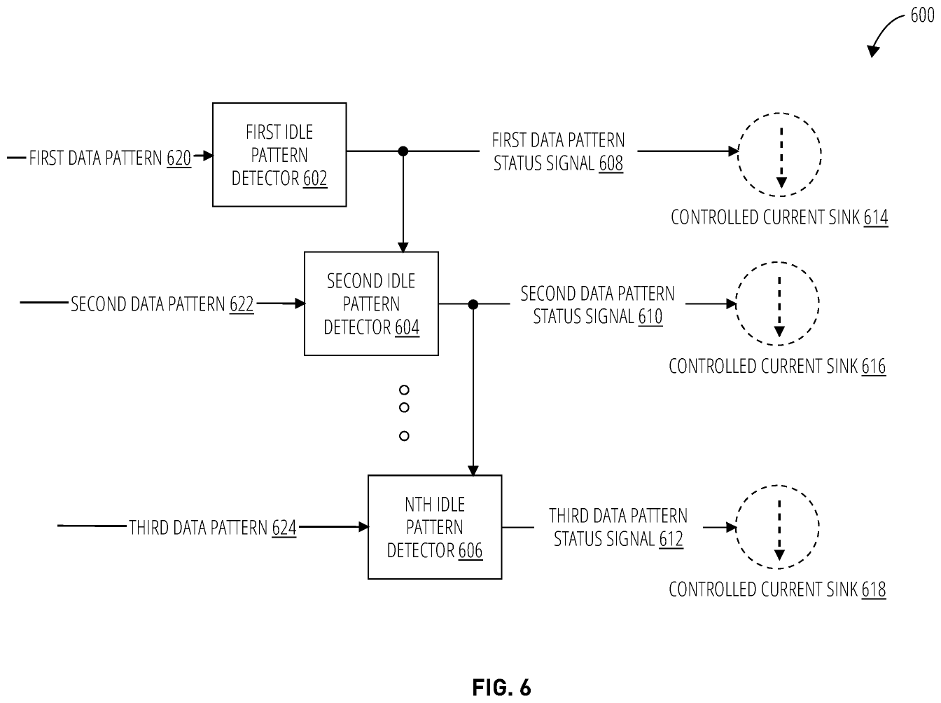

FIG. 6 is a block diagram of an apparatus 600 that aligns power modulation in a sequential manner, in accordance with one or more examples. Respective data-dependent power compensators or data pattern detectors of apparatus 600 are set to align sequential power modulation, that is, power modulation by at least some of the data-dependent power compensators or the setting of data pattern status signals is conditioned upon power modulation of one or more of the other data-dependent power compensators or data pattern status signals of one or more other data pattern detectors.

Apparatus 600 includes 1 to N idle pattern detectors and optionally includes 1 to N controlled current sinks. The 1 to N idle pattern detectors include first idle pattern detector 602, second idle pattern detector 604 and Nth idle pattern detector 606. The optional 1 to N controlled current sinks include controlled current sink 614, controlled current sink 616 and controlled current sink 618.

First idle pattern detector 602 receives first data pattern 620 and generates first data pattern status signal 608 at least partially responsive thereto. Second idle pattern detector 604 receives second data pattern 622 and is coupled to receive first data pattern status signal 608 from first idle pattern detector 602. Second idle pattern detector 604 generates second data pattern status signal 610 at least partially responsive to second data pattern 622 and first data pattern status signal 608. Nth idle pattern detector 606 receives third data pattern 624 and is coupled to receive second data pattern status signal 610 from second idle pattern detector 604. Nth idle pattern detector 606 generates third data pattern status signal 612 at least partially responsive to third data pattern 624 and second data pattern status signal 610.

More specifically, second idle pattern detector 604 asserts second data pattern status signal 610 only if it detects the presence of an idle pattern in second data pattern 622 and first data pattern status signal 608 is asserted, i.e., that first idle pattern detector 602 detected the presence of an idle patter in first data pattern 620. Nth idle pattern detector 606 asserts third data pattern status signal 612 only if it detects the presence of an idle data pattern in third data pattern 624 and second data pattern status signal 610 is asserted.

By way of non-limiting example, if Nth idle pattern detector 606 detects the presence of an idle data pattern earlier in time than second idle pattern detector 604 and thus second data pattern status signal 610 is de-asserted when Nth idle pattern detector 606 detects the idle data pattern, then Nth idle pattern detector 606 will not assert third data pattern status signal 612 unless or until second idle pattern detector 604 asserts second data pattern status signal 610. Similarly, second idle pattern detector 604 will not assert second data pattern status signal 610 unless or until first idle pattern detector 602 asserts first data pattern status signal 608.

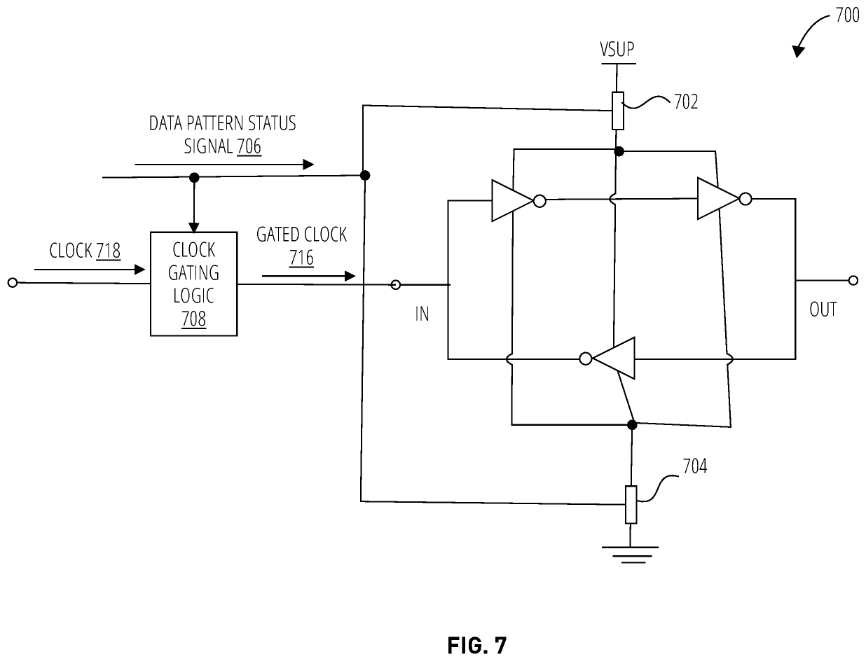

FIG. 7 is a schematic diagram of a current sink 700 activated in response to a detection signal generated by an idle pattern detector or a control signal generated in response to detection signals generated by multiple data pattern detectors, in accordance with one or more examples.

Current sink 700 includes multiple Complementary Metal-Oxide-Semiconductor (CMOS) inverters (three CMOS inverters are depicted in FIG. 7, but more or fewer may be included without exceeding the scope of this disclosure). The CMOS inverters are coupled in series when their respective positive power inputs are coupled to voltages VSUP and their respective negative power inputs are coupled to Ground. When active, a respective CMOS inverter acts as a current sink. The amount of current drawn by current sink 700 when it is on may be set, as a non-limiting example, based on the number of CMOS inverters present.

The respective CMOS inverters are selectively coupled to VSUP and ground by switch 702 and switch 704, respectively. When switch 702 and switch 704 are ON they permit current to flow between the CMOS inverters and VSUP and Ground. When switch 702 and switch 704 are OFF, they are high impedance or open and they do not permit current to flow.

Switch 702 and switch 704 are controlled by (i.e., turn ON and OFF in response to) data pattern status signal 706. In one or more examples, data pattern status signal 706 may be generated by any of the idle pattern detectors discussed herein, including data pattern detector 102, apparatus 300, apparatus 400, data pattern detectors 502, first idle pattern detector 602, second idle pattern detector 604, or Nth idle pattern detector 606.

When switches 702 and switch 704 are ON, clock gating logic 708 may selectively provide gated clock 716 based on clock 718. Any source or sources of clock 718 may be utilized. In one or more examples, clock 718 may be, or be based on, a clock utilized by a data-dependent power consumer such as data converter 202, without limitation, so that the power modulation by current sink 700 aligns temporarily with the change in power consumption of the data-dependent power consumer.

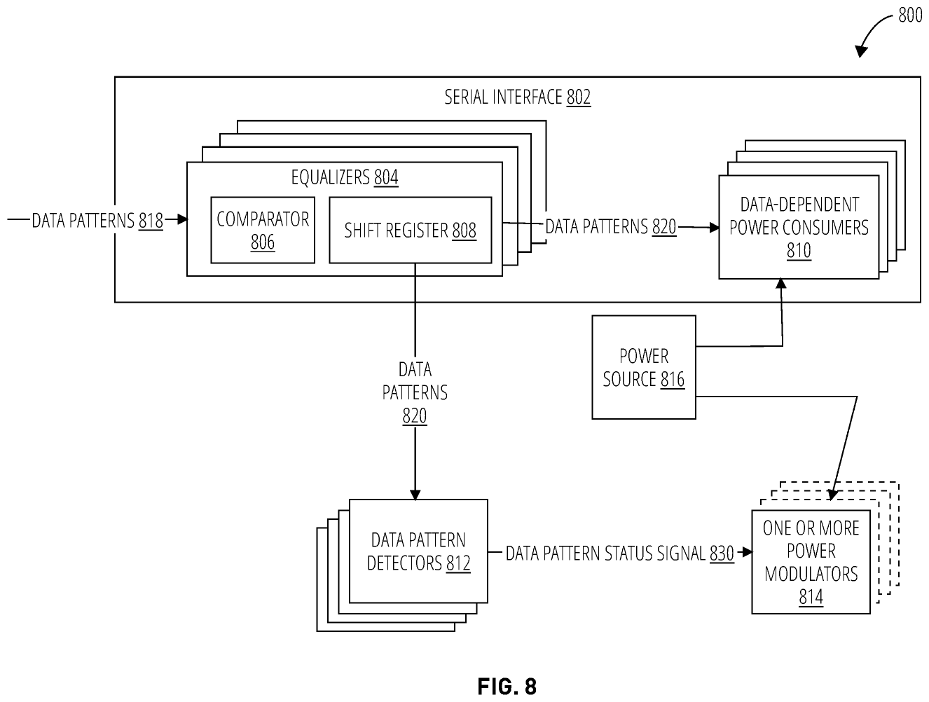

FIG. 8 is a block diagram depicting a system 800 that compensates for reduced power consumption by data-dependent power consumers of a serial interface, in accordance with one or more examples. The data-dependent power consumers may be, as non examples, data converters such as ADCs or DACs.

System 800 includes serial interface 802, data pattern detectors 812, one or more power modulators 814 and power source 816. Serial interface 802 includes equalizers 804 and data-dependent power consumers 810. Equalizers 804 respectively include comparator 806 and shift register 808.

Equalizers 804 perform equalization on data patterns 818 and generate equalized data patterns 820 responsive thereto. Equalization reduces channel-induced impairments in a high-speed serial link, such as inter-symbol interference (ISI), without limitation. Equalizers 804 may be respective instances of a Decision Feedback Equalizer (DFE) in the case of a receiver, or respective instances of a Feed Forward Equalizer (FFE) in the case of a transmitter. Respective shift register 808 of equalizers 804 are coupled to data pattern detectors 812 to provide equalized data patterns 820 or portions thereof (e.g., history symbols and current symbols, without limitation) to data pattern detectors 812 and data-dependent power consumers 810. Notably, while data-dependent power consumers 810 are depicted as a separate block than equalizers 804, some or a totality of data-dependent power consumers 810 may be, or be a part of, equalizers 804.

In one or more examples, equalization taps (e.g., DFE taps, FFE taps, without limitation) may store history symbols, and those taps may be available and data pattern detectors 812 may receive history symbols of data patterns 820 from those taps.

Data pattern detectors 812 determine the data pattern status of equalized data patterns 820 as discussed above and generate respective data pattern status signal 830 to indicate the determined data pattern status. One or more power modulators 814 modulate power from power source 816 at system 800 based on the respective data pattern status signal 830.

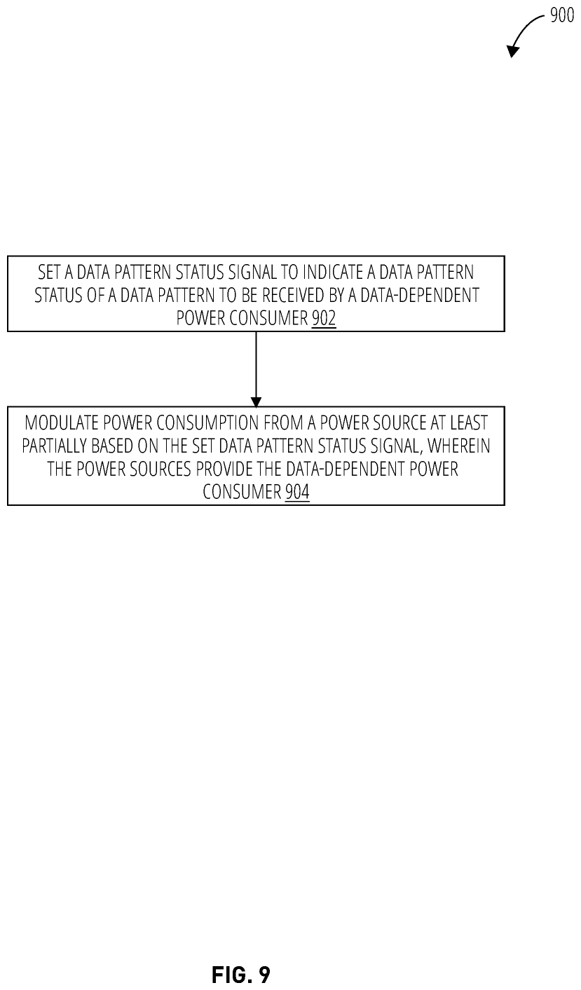

FIG. 9 is a flow diagram depicting a process 900 of compensating for reduced power consumption due to data-dependent power consumption, in accordance with one or more examples. Some or a totality of operations of process 900 may be performed, as a non-limiting example, by apparatus 100, system 200, apparatus 300, apparatus 400, apparatus 500, apparatus 600, or apparatus 800

Although the example process 900 depicts a particular sequence of operations, the sequence may be altered without departing from the scope of the present disclosure. For example, some of the operations depicted may be performed in parallel or in a different sequence that does not materially affect the function of the process 900. In other examples, different components of an example device or system that implements the process 900 may perform functions at substantially the same time or in a specific sequence.

According to one or more examples, process 900 includes setting a data pattern status signal to indicate a data pattern status of a data pattern to be received by a data-dependent power consumer at operation 902.

According to one or more examples, process 900 includes modulating power consumption from a power source that provides power to the data-dependent power consumer at least partially based on the set data pattern status signal operation 904.

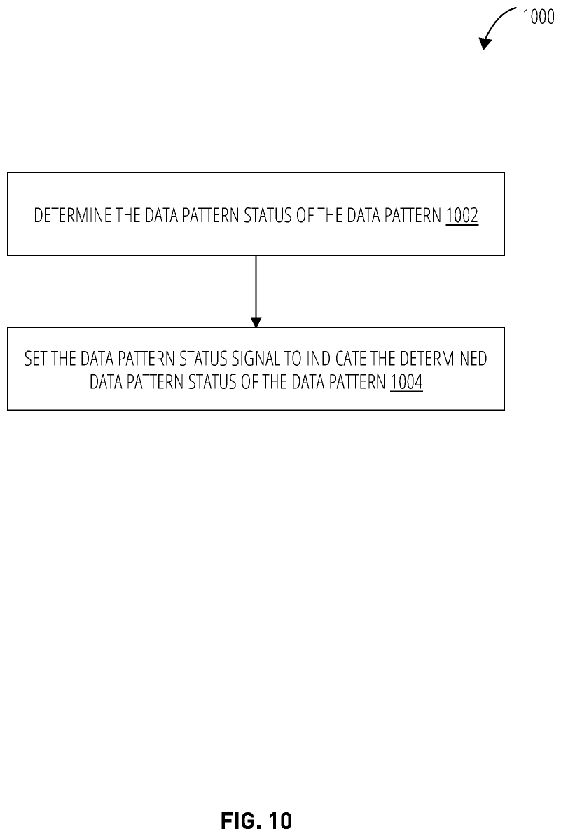

FIG. 10 is a flow diagram depicting a process 1000 of setting the data pattern status signal to indicate a data pattern status of a data pattern to be received by a data-dependent power consumer, in accordance with one or more examples. Some or a totality of operations of process 1000 may be performed, as a non-limiting example, by apparatus 100, system 200, apparatus 300, apparatus 400, apparatus 500, apparatus 600, or system 800.

Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to one or more examples, process 1000 includes determining the data pattern status of the data pattern at operation 1002.

According to one or more examples, process 1000 includes setting the data pattern status signal to indicate the determined data pattern status of the data pattern at operation 1004.

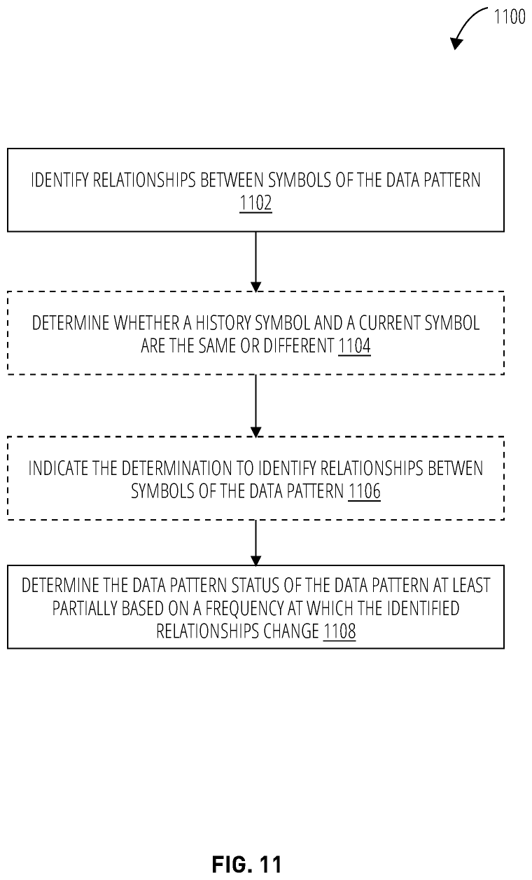

FIG. 11 is a flow diagram depicting a process 1100 of a data pattern status of a data pattern at least partially based relationships of symbols of the data pattern, in accordance with one or more examples. Some or a totality of operations of process 1100 may be performed, as a non-limiting example, by apparatus 100, system 200, apparatus 300, apparatus 500, apparatus 600, or apparatus 800.

Although the example process 1100 depicts a particular sequence of operations, the sequence may be altered without departing from the scope of the present disclosure. For example, some of the operations depicted may be performed in parallel or in a different sequence that does not materially affect the function of the process 1100. In other examples, different components of an example device or system that implements the process 1100 may perform functions at substantially the same time or in a specific sequence.

According to one or more examples, process 1100 optionally includes determining whether a history symbol and a current symbol are the same or different at operation 1104. The relationship between symbols of the data pattern determined in operation 1102 may be based on the determination in optional operation 1104. If the history symbol and current symbol are the same, then the relationship may be determined to that the current symbol is the same as the history symbol. If the history symbol and current symbol are different, then the relationship may be determined to that the history symbol is different than he current symbol.

According to one or more examples, process 1100 includes determining whether a history symbol and a current symbol are the same or different at operation 1104.

According to one or more examples, process 1100 optionally includes indicating the determination to identify relationships between symbols of the data pattern at operation 1106. In one or more examples, such an indication may be a value in a series (e.g., a time series, without limitation) of values representing the relationships between symbols. In one or more examples, respective values of such a series may represent whether or not respective current symbols and history symbols were the same or different. According to one or more examples, process 1100 includes determining the data pattern status of the data pattern at least partially based on a frequency at which the identified relationships change at operation 1108.

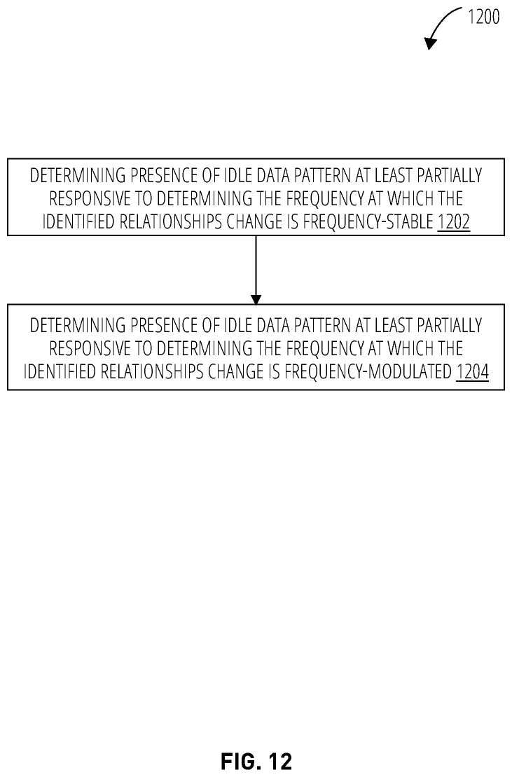

FIG. 12 is a flow diagram depicting a process 1200 of determining data pattern status of the data pattern at least partially based on a frequency at which the identified relationships change, in accordance with one or more examples. Some or a totality of operations of process 1200 may be performed, as a non-limiting example, by apparatus 100, system 200, apparatus 400, apparatus 500, apparatus 600, or apparatus 800.

Although the example process 1200 depicts a particular sequence of operations, the sequence may be altered without departing from the scope of the present disclosure. For example, some of the operations depicted may be performed in parallel or in a different sequence that does not materially affect the function of the process 1200. In other examples, different components of an example device or system that implements the process 1200 may perform functions at substantially the same time or in a specific sequence.

According to one or more examples, process 1200 includes determining presence of idle data pattern at least partially responsive to determining the frequency at which the identified relationships of operation 1102 change is frequency-stable at operation 1202.

According to one or more examples, process 1200 includes determining presence of idle data pattern at least partially responsive to determining the frequency at which the identified relationships change of operation 1102 is frequency-modulating at operation 1204.

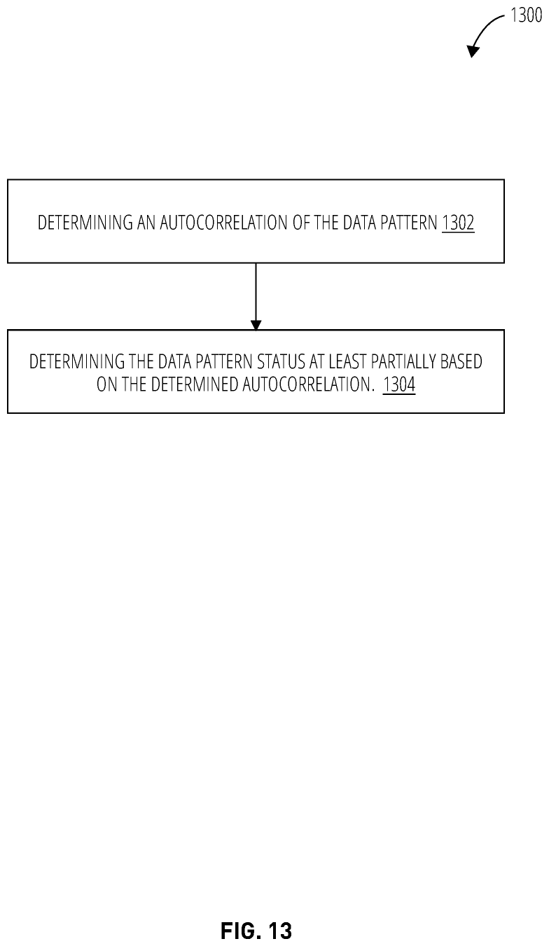

FIG. 13 is a flow diagram depicting a process 1300 of determining data pattern status of the data pattern based on autocorrelations, in accordance with one or more examples. Some or a totality of operations of process 1300 may be performed, as a non-limiting example, by apparatus 100, system 200, apparatus 400, apparatus 500, apparatus 600, or apparatus 800.

Although the example process 1300 depicts a particular sequence of operations, the sequence may be altered without departing from the scope of the present disclosure. For example, some of the operations depicted may be performed in parallel or in a different sequence that does not materially affect the function of the process 1300. In other examples, different components of an example device or system that implements the process 1300 may perform functions at substantially the same time or in a specific sequence.

According to one or more examples, process 1300 includes determining an autocorrelation of the data pattern at operation 1302.

According to one or more examples, process 1300 includes determining the data pattern status at least partially based on the determined autocorrelation at operation 1304.

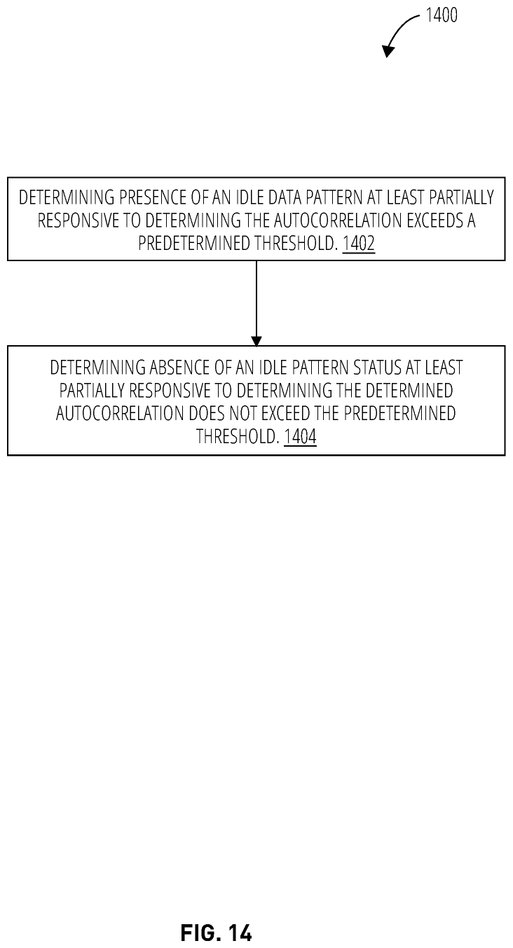

FIG. 14 illustrates an example process 1400 of determining data pattern status of the data pattern based on autocorrelations, in accordance with one or more examples. Some or a totality of operations of process 1400 may be performed, as a non-limiting example, by apparatus 100, system 200, apparatus 400, apparatus 500, apparatus 600, or apparatus 800.

Although the example process 1400 depicts a particular sequence of operations, the sequence may be altered without departing from the scope of the present disclosure. For example, some of the operations depicted may be performed in parallel or in a different sequence that does not materially affect the function of the process 1400. In other examples, different components of an example device or system that implements the process 1400 may perform functions at substantially the same time or in a specific sequence.

According to one or more examples, process 1400 includes determining presence of an idle data pattern at least partially responsive to determining the determined autocorrelation of operation 1302 exceeds a predetermined threshold at operation 1402.

According to one or more examples, process 1400 includes determining absence of an idle pattern status at least partially responsive to determining the determined autocorrelation of operation 1302 does not exceed the predetermined threshold at operation 1404.

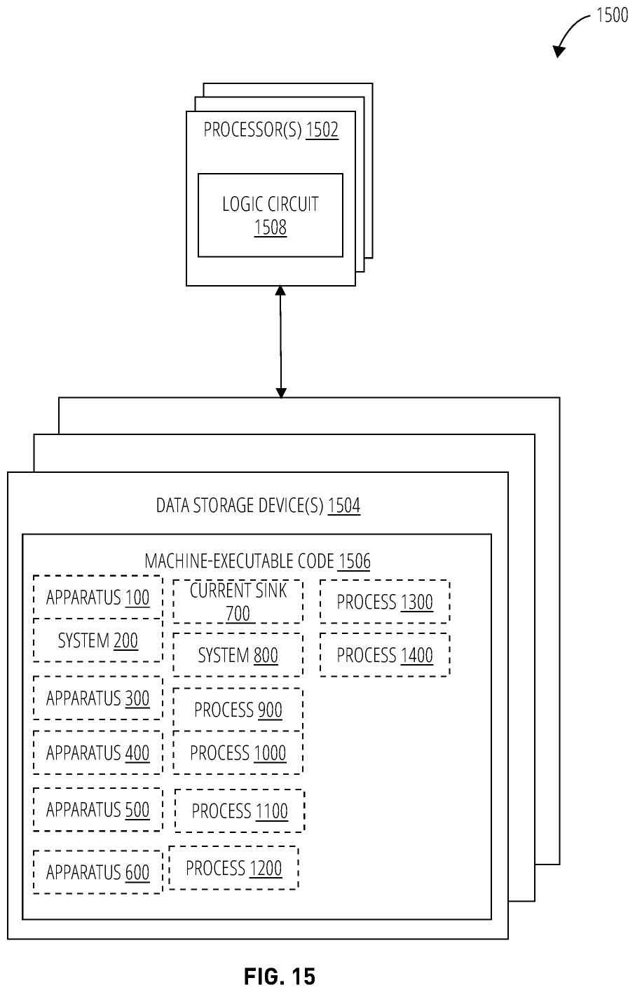

It will be appreciated by those of ordinary skill in the art that functional elements of examples disclosed herein (e.g., functions, operations, acts, processes, or methods) may be implemented in any suitable hardware, software, firmware, or combinations thereof. FIG. 15 illustrates non-limiting examples of implementations of functional elements disclosed herein. In some examples, some or all portions of the functional elements disclosed herein may be performed by hardware specially for carrying out the functional elements.

FIG. 15 is a block diagram of a circuitry 1500 that, in some examples, may be used to implement various functions, operations, acts, processes, or methods disclosed herein. The circuitry 1500 includes one or more processors 1502 (sometimes referred to herein as “processors 1502”) operably coupled to one or more data storage devices 1504 (sometimes referred to herein as “storage 1504”). The storage 1504 includes machine-executable code 1506 stored thereon and the processors 1502 include logic circuit 1508. The machine-executable code 1506 information describing functional elements that may be implemented by (e.g., performed by) the logic circuit 1508. The logic circuit 1508 is adapted to implement (e.g., perform) the functional elements described by the machine-executable code 1506. The circuitry 1500, when executing the functional elements described by the machine-executable code 1506, should be considered as special purpose hardware for carrying out functional elements disclosed herein. In some examples the processors 1502 may perform the functional elements described by the machine-executable code 1506 sequentially, concurrently (e.g., on one or more different hardware platforms), or in one or more parallel process streams.

When implemented by logic circuit 1508 of the processors 1502, the machine-executable code 1506 adapts the processors 1502 to perform operations of examples disclosed herein. By way of non-limiting example, the machine-executable code 1506 may adapt the processors 1502 to perform some or a totality of operations of one or more of: data pattern status determination, idle data pattern detection, and data-dependent power compensation discussed herein. By way of non-limiting example, the machine-executable code 1506 may adapt the processors 1502 to perform some or a totality of operations of one or more of: process 900, process 1000, process 1100, process 1200, process 1300, process 1400.

Also by way of non-limiting example, the machine-executable code 1506 may adapt the processors 1502 to perform some or a totality of features, functions, or operations disclosed herein for one or more of: apparatus 100, system 200, apparatus 300, apparatus 400, apparatus 500, apparatus 600, current sink 700, or system 800. More specifically, features, functions, or operations disclosed herein for one or more of: data pattern detector 102, power modulator 104; data converter 202, power source 204; shift register 302, XOR gate 304, filter 306, controlled current sink 308; one or more delays 402, binary multiplier 404, data pattern 406, accumulator 410, threshold detector 412; data pattern detectors 502, multi-input AND Gate 504, controlled current sink 506; first idle pattern detector 602, second idle pattern detector 604, Nth idle pattern detector 606, controlled current sink 614, controlled current sink 616, controlled current sink 618; switch 702, switch 704, clock gating logic 708, CMOS inverters; serial interface 802, equalizers 804, comparator 806, shift register 808, data-dependent power consumers 810, data pattern detectors 812, one or more power modulators 814, or power source 816.

The processors 1502 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to the machine-executable code 1506 (e.g., software code, firmware code, hardware descriptions) related to examples of the present disclosure. It is noted that a general-purpose processor (may also be referred to herein as a host processor or simply a host) may be a microprocessor, but in the alternative, the processors 1502 may include any conventional processor, controller, microcontroller, or state machine. The processors 1502 may also be implemented as a combination of computing devices, such as a combination of a DSP and a microprocessor, a plurality of microprocessors, one or more microprocessors in conjunction with a DSP core, or any other such configuration.

In some examples the storage 1504 includes volatile data storage (e.g., random-access memory (RAM)), non-volatile data storage (e.g., Flash memory, a hard disc drive, a solid state drive, erasable programmable read-only memory (EPROM), without limitation). In some examples the processors 1502 and the storage 1504 may be implemented into a single device (e.g., a semiconductor device product, a system on chip (SOC), without limitation). In some examples the processors 1502 and the storage 1504 may be implemented into separate devices.

In some examples the machine-executable code 1506 may include computer-readable instructions (e.g., software code, firmware code). By way of non-limiting example, the computer-readable instructions may be stored by the storage 1504, accessed directly by the processors 1502, and executed by the processors 1502 using at least the logic circuit 1508. Also by way of non-limiting example, the computer-readable instructions may be stored on the storage 1504, transferred to a memory device (not shown) for execution, and executed by the processors 1502 using at least the logic circuit 1508. Accordingly, in some examples the logic circuit 1508 includes electrically configurable logic circuit 1508.

In some examples the machine-executable code 1506 may describe hardware (e.g., circuitry) to be implemented in the logic circuit 1508 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG®, SYSTEMVERILOG™ or very large-scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuit 1508 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine-executable code 1506 may include an HDL, an RTL, a GL description, a mask level description, other hardware description, or any combination thereof.

In examples where the machine-executable code 1506 includes a hardware description (at any level of abstraction), a system (not shown, but including the storage 1504) may implement the hardware description described by the machine-executable code 1506. By way of non-limiting example, the processors 1502 may include a programmable logic device (e.g., an FPGA or a PLC) and the logic circuit 1508 may be electrically controlled to implement circuitry corresponding to the hardware description into the logic circuit 1508. Also by way of non-limiting example, the logic circuit 1508 may include hard-wired logic manufactured by a manufacturing system (not shown, but including the storage 1504) according to the hardware description of the machine-executable code 1506.

Regardless of whether the machine-executable code 1506 includes computer-readable instructions or a hardware description, the logic circuit 1508 is adapted to perform the functional elements described by the machine-executable code 1506 when implementing the functional elements of the machine-executable code 1506. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations that perform the actions of the module or component and/or software objects or software routines that may be stored on and/or executed by general purpose hardware (e.g., computer-readable media, processing devices, without limitation) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims, without limitation) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, the term “each” means “some or a totality.” As used herein, the term “each and every” means a “totality.”

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more,” without limitation); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations, without limitation). Furthermore, in those instances where a convention analogous to “at least one of A, B, and C, without limitation” or “one or more of A, B, and C, without limitation” is used, in general such a construction is intended to include A alone, B alone, C alone, A and B together, A and C together, B and C together, or A, B, and C together, without limitation.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples include:

Example 1: An apparatus, comprising: a data pattern detector to set a data pattern status signal to indicate a data pattern status of a data pattern to be received by a data-dependent power consumer; and a power modulator to set a power state of the power modulator at least partially based on the data pattern status signal.

Example 2: The apparatus according to Example 1, wherein the data pattern status determined by the data pattern detector includes presence of an idle data pattern.

Example 3: The apparatus according to any of Examples 1 and 2, wherein the data pattern detector comprises an autocorrelator and the data pattern detector sets the data pattern status signal at least partially based on an output of the autocorrelator.

Example 4: The apparatus according to any of Examples 1 through 3, wherein the data pattern detector comprises: an XOR gate to continuously compare symbols presented at its inputs on every clock cycle, and generate an output to indicate a difference between the symbols; and a filter to process the output of the XOR gate and set an output of the filter to indicate a frequency-stability of the output of the XOR gate.

Example 5: The apparatus according to any of Examples 1 through 4, comprising: a shift-register to continuously present symbols of the data pattern to the inputs of the XOR gate via action of the shift-register.

Example 6: The apparatus according to any of Examples 1 through 5, wherein respective symbols of the data pattern presented to the inputs of the XOR gate include a current symbol and a history symbol.

Example 7: The apparatus according to any of Examples 1 through 6, comprising: a power source to provide power to the power modulator, wherein power consumed from the power source by the power modulator is at least partially based on the power state of the power modulator.

Example 8: The apparatus according to any of Examples 1 through 7, wherein the power source to provide power to the data-dependent power consumer.

Example 9: The apparatus according to any of Examples 1 through 8, wherein the data-dependent power consumer comprises a data converter.

Example 10: The apparatus according to any of Examples 1 through 9, wherein the data pattern detector comprises: a multi-input AND gate; and multiple data pattern detectors, respective outputs of the multiple data pattern detectors coupled to respective inputs of the multi-input AND gate.

Example 11: The apparatus according to any of Examples 1 through 10, wherein the power modulator comprises a current sink.

Example 12: The apparatus according to any of Examples 1 through 11, wherein the current sink comprises one or more CMOS inverters.

Example 13: A method, comprising: setting a data pattern status signal to indicate a data pattern status of a data pattern to be received by a data-dependent power consumer; and modulating power consumption from a power source at least partially based on the set data pattern status signal, wherein the power source provides power to the data-dependent power consumer.

Example 14: The method according to Example 13, comprising: determining the data pattern status of the data pattern; and setting the data pattern status signal to indicate the determined data pattern status of the data pattern.

Example 15: The method according to any of Examples 13 and 14, wherein determining the data pattern status of the data pattern comprises: identifying relationships between symbols of the data pattern; and determining the data pattern status of the data pattern at least partially based on a frequency at which the identified relationships change.

Example 16: The method according to any of Examples 13 through 15, wherein identifying relationships between symbols of the data pattern comprises: determining whether a history symbol and a current symbol are the same or different; and indicating the determination.

Example 17: The method according to any of Examples 13 through 16, wherein determining the data pattern status of the data pattern at least partially based on the frequency at which the identified relationships change comprises: determining presence of idle data pattern at least partially responsive to determining the frequency at which the identified relationships change is frequency-stable.

Example 18: The method according to any of Examples 13 through 17, wherein determining the data pattern status of the data pattern at least partially based on the frequency at which the identified relationships change comprises: determining absence of idle data pattern at least partially responsive to determining the frequency at which the identified relationships change is frequency-modulating.

Example 19: The method according to any of Examples 13 through 18, wherein determining the data pattern status of the data pattern comprises: determining an autocorrelation of the data pattern; and determining the data pattern status at least partially based on the determined autocorrelation.

Example 20: The method according to any of Examples 13 through 19, wherein determining the data pattern status at least partially based on the determined autocorrelation comprises: determining presence of an idle data pattern at least partially responsive to determining the autocorrelation of the data pattern exceeds a predetermined threshold.

Example 21: The method according to any of Examples 13 through 20, wherein determining the data pattern status at least partially based on the determined autocorrelation comprises: determining absence of an idle pattern status at least partially responsive to determining the determined autocorrelation does not exceed the predetermined threshold.

Example 22: A system, comprising: a serial interface including multiple lanes and multiple data-dependent power consumers; a power source to provide power to the multiple data-dependent power consumers; multiple data pattern detectors to set respective data pattern status signals to indicate data pattern status of data patterns received at respective ones of the multiple lanes of the serial interface; and one or more power modulators to set power consumed from the power source by the one more power modulators at least partially based on the data pattern status signals.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. An apparatus, comprising:
a data pattern detector to set a data pattern status signal to indicate a data pattern status of a data pattern to be received by a data-dependent power consumer; and
a power modulator to set a power state of the power modulator at least partially based on the data pattern status signal.

2. The apparatus of claim 1, wherein the data pattern status determined by the data pattern detector includes presence of an idle data pattern.

3. The apparatus of claim 1, wherein the data pattern detector comprises an autocorrelator and the data pattern detector sets the data pattern status signal at least partially based on an output of the autocorrelator.

4. The apparatus of claim 1, wherein the data pattern detector comprises:
an XOR gate to continuously compare symbols presented at its inputs on every clock cycle, and generate an output to indicate a difference between the symbols; and
a filter to process the output of the XOR gate and set an output of the filter to indicate a frequency-stability of the output of the XOR gate.

5. The apparatus of claim 4, comprising:
a shift-register to continuously present symbols of the data pattern to the inputs of the XOR gate via action of the shift-register.

6. The apparatus of claim 5, wherein respective symbols of the data pattern presented to the inputs of the XOR gate include a current symbol and a history symbol.

7. The apparatus of claim 1, comprising:
a power source to provide power to the power modulator, wherein power consumed from the power source by the power modulator is at least partially based on the power state of the power modulator.

8. The apparatus of claim 7, wherein the power source to provide power to the data-dependent power consumer.

9. The apparatus of claim 8, wherein the data-dependent power consumer comprises a data converter.

10. The apparatus of claim 1, wherein the data pattern detector comprises:
a multi-input AND gate; and
multiple data pattern detectors, respective outputs of the multiple data pattern detectors coupled to respective inputs of the multi-input AND gate.

11. The apparatus of claim 1, wherein the power modulator comprises a current sink.

12. The apparatus of claim 11, wherein the current sink comprises one or more CMOS inverters.

13. A method, comprising:
setting a data pattern status signal to indicate a data pattern status of a data pattern to be received by a data-dependent power consumer; and
modulating power consumption from a power source at least partially based on the set data pattern status signal, wherein the power source provides power to the data-dependent power consumer.

14. The method of claim 13, comprising:
determining the data pattern status of the data pattern; and
setting the data pattern status signal to indicate the determined data pattern status of the data pattern.

15. The method of claim 14, wherein determining the data pattern status of the data pattern comprises:
identifying relationships between symbols of the data pattern; and
determining the data pattern status of the data pattern at least partially based on a frequency at which the identified relationships change.

16. The method of claim 15, wherein identifying relationships between symbols of the data pattern comprises:
determining whether a history symbol and a current symbol are the same or different; and
indicating the determination.

17. The method of claim 15, wherein determining the data pattern status of the data pattern at least partially based on the frequency at which the identified relationships change comprises:
determining presence of idle data pattern at least partially responsive to determining the frequency at which the identified relationships change is frequency-stable.

18. The method of claim 15, wherein determining the data pattern status of the data pattern at least partially based on the frequency at which the identified relationships change comprises:
determining absence of idle data pattern at least partially responsive to determining the frequency at which the identified relationships change is frequency-modulating.

19. The method of claim 14, wherein determining the data pattern status of the data pattern comprises:
determining an autocorrelation of the data pattern; and
determining the data pattern status at least partially based on the determined autocorrelation.

20. The method of claim 19, wherein determining the data pattern status at least partially based on the determined autocorrelation comprises:
determining presence of an idle data pattern at least partially responsive to determining the autocorrelation of the data pattern exceeds a predetermined threshold.

21. The method of claim 20, wherein determining the data pattern status at least partially based on the determined autocorrelation comprises:
determining absence of an idle pattern status at least partially responsive to determining the determined autocorrelation does not exceed the predetermined threshold.

22. A system, comprising:
a serial interface including multiple lanes and multiple data-dependent power consumers;
a power source to provide power to the multiple data-dependent power consumers;
multiple data pattern detectors to set respective data pattern status signals to indicate data pattern status of data patterns received at respective ones of the multiple lanes of the serial interface; and
one or more power modulators to set power consumed from the power source by the one more power modulators at least partially based on the data pattern status signals.
